(19) United States
(12) Patent Application Publication
(10) Pub. No.: US 2011/0119118 A1
(43) Pub. Date: May 19, 2011

(54) System and Method for Providing Automated Fee Pricing

(75) Inventors: Mark P. Miller, Plano, TX (US); Ronald F. LeBeau, Rochester, NY (US)

(73) Assignee: BANK OF AMERICA CORPORATION, Charlotte, NC (US)

(21) Appl. No.: 12/618,127

(22) Filed: Nov. 13, 2009

(51) Int. Cl. G06Q 40/00; G06Q 10/00; G06Q 30/00

(52) U.S. Cl. 705/14.1; 705/400

(57) ABSTRACT

A system includes a memory and a processor communicatively coupled to the memory. The memory is operable to store a list of fee rules and a fee schedule. The processor is operable to receive account data comprising an asset type and an asset value associated with the asset type. The processor is further operable to determine, based on the asset type, one or more rules for calculating asset management fees from the list of fee rules and to calculate a standard asset management fee based on the received account data, the determined one or more rules, and the fee schedule. The processor is further operable to receive a discount factor associated with the standard asset management fee and to calculate an adjusted asset management fee based on the discount factor and the standard asset management fee.

### TECHNICAL FIELD OF THE INVENTION

The present invention relates generally to financial services and more specifically to a system and method for providing automated fee pricing.

### BACKGROUND OF THE INVENTION

Financial institutions such as banks provide many services to their clients. As compensation for these services, clients are often charged various fees. Because each client typically has more than one asset type to manage, multiple fees must be calculated. The calculation of the fees is typically a manual process that requires significant amounts of time and research.

### SUMMARY OF THE INVENTION

In accordance with the present invention, the disadvantages and problems associated with prior fee pricing methods have been substantially reduced or eliminated.

According to one embodiment of the present invention, a system includes a memory and a processor communicatively coupled to the memory. The memory is operable to store a list of fee rules and a fee schedule. The processor is operable to receive account data comprising an asset type and an asset value associated with the asset type. The processor is further operable to determine, based on the asset type, one or more rules for calculating asset management fees from the list of fee rules and to calculate a standard asset management fee based on the received account data, the determined one or more rules, and the fee schedule. The processor is further operable to receive a discount factor associated with the standard asset management fee and to calculate an adjusted asset management fee based on the discount factor and the standard asset management fee.

Certain embodiments of the disclosure may provide one or more technical advantages. A technical advantage of one embodiment may be that standard fee pricing may be provided quickly, efficiently, and accurately. A technical advantage of another embodiment may be that a discount factor may be utilized to provide adjusted fee pricing. Some embodiments may provide additional advantages by providing a comparison of standard fees and adjusted fees.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its advantages, reference is now made to the following description taken in conjunction with the accompanying drawings, in which:

FIG. 1 illustrates a system for providing automated fee pricing, according to certain embodiments;

FIG. 2 illustrates an example screenshot of an account information window that may be generated by the system of FIG. 1, according to certain embodiments;

FIG. 3 illustrates a list of fee rules that may be utilized by the system of FIG. 1, according to certain embodiments;

FIG. 4 illustrates a fee schedule that may be utilized by the system of FIG. 1, according to certain embodiments;

FIG. 5 illustrates an example screenshot of a standard pricing window that may be generated by the system of FIG. 1, according to certain embodiments;

FIG. 6 illustrates an example screenshot of a discount modeling window that may be generated by the system of FIG. 1, according to certain embodiments;

FIG. 7 illustrates an example screenshot of a pricing comparison window that may be generated by the system of FIG. 1, according to certain embodiments; and

FIG. 8 illustrates a method for automated fee pricing, according to certain embodiments.

### DETAILED DESCRIPTION OF THE INVENTION

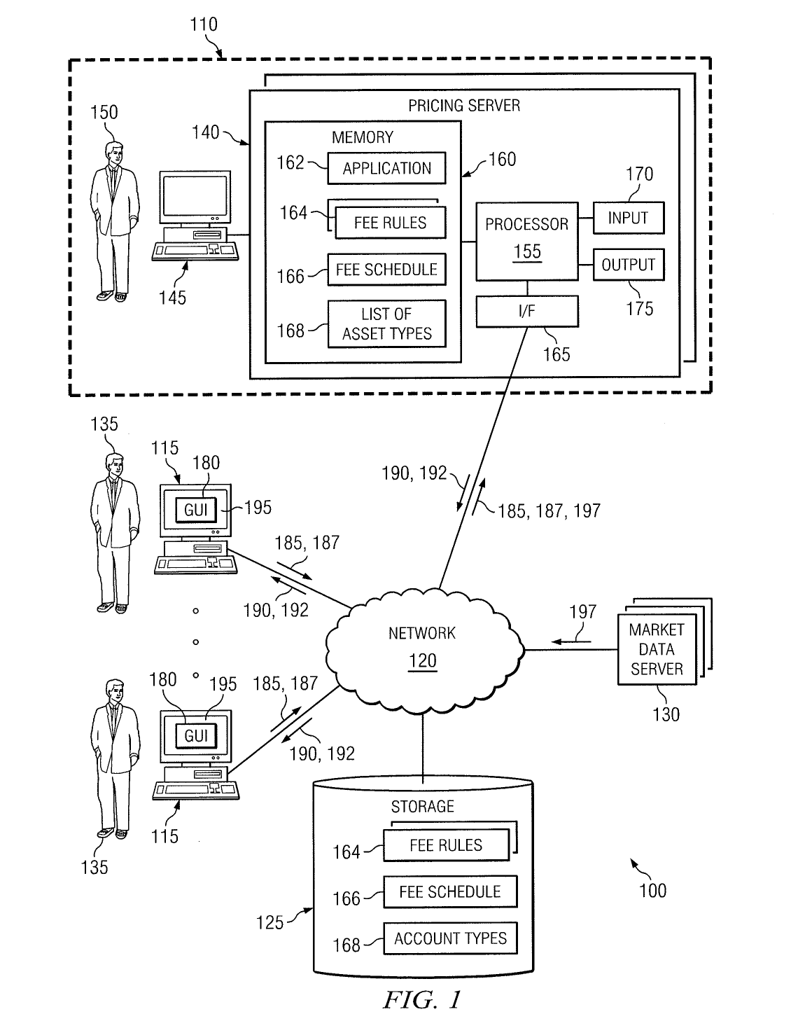

Embodiments of the present invention and its advantages are best understood by referring to FIGS. 1 through 8 of the drawings, like numerals being used for like and corresponding parts of the various drawings.

Banks and other financial institutions typically have many types of clients and customers. For example, one type of customer is a high net worth client who has assets that are managed by the bank. As compensation for services provided to their customers, banks typically charge various fees. However, typical fee calculation techniques are performed manually and usually require significant time and resources. In addition, typical methods of calculating fees often require complex calculations and do not provide an easy way to account for discounted fees. As a result, typical methods of calculating fees result in inconsistent and unreliable results.

The teachings of the disclosure recognize that it would be desirable to provide automated fee pricing that takes into account discounted fees. FIGS. 1 through 8 below illustrate a system and method of providing automated fee pricing according to the teachings of the disclosure.

FIG. 1 illustrates a system 100 according to certain embodiments. System 100 may include an enterprise 110, one or more clients 115, a network storage device 125, one or more market data servers 130, one or more pricing servers 140, and one or more users 135. Enterprise 110, clients 115, network storage device 125, and market data servers 130 may be communicatively coupled by a network 120. Enterprise 110 is generally operable to provide automated fee pricing to users 135 as described below.

In general, one or more pricing servers 140 provide automated fee pricing to users 135. User 135 may first provide account data 185 to pricing server 140 by utilizing client 115. Pricing server 140 may then calculate and provide standard asset management fees 190 to user 135 according to account data 185 provided by user 135. A standard asset management fee may refer to any typical and/or non-reduced fee charged to a customer for managing an asset. User 135 may then provide discount factors 187 to pricing server 140 to reduce the calculated standard asset management fees 190. In some embodiments, pricing server 140 may then generate and provide a pricing comparison 192 to user 135. As a result, user 135 may easily and quickly have a clear view of asset management fees to be charged to a customer of enterprise 110.

Client 115 may refer to any device that enables user 135 to interact with pricing server 140. In some embodiments, client 115 may include a computer, workstation, telephone, Internet browser, electronic notebook, Personal Digital Assistant (PDA), pager, or any other suitable device (wireless, wireline, or otherwise), component, or element capable of receiving, processing, storing, and/or communicating information with other components of system 100. Client 115 may also comprise any suitable user interface such as a display 195, microphone, keyboard, or any other appropriate terminal equipment usable by a user 135. It will be understood that system 100 may comprise any number and combination of clients 115. Client 115 may be utilized by user 155 to interact with pricing server 140 in order to receive automated fee pricing as described below.

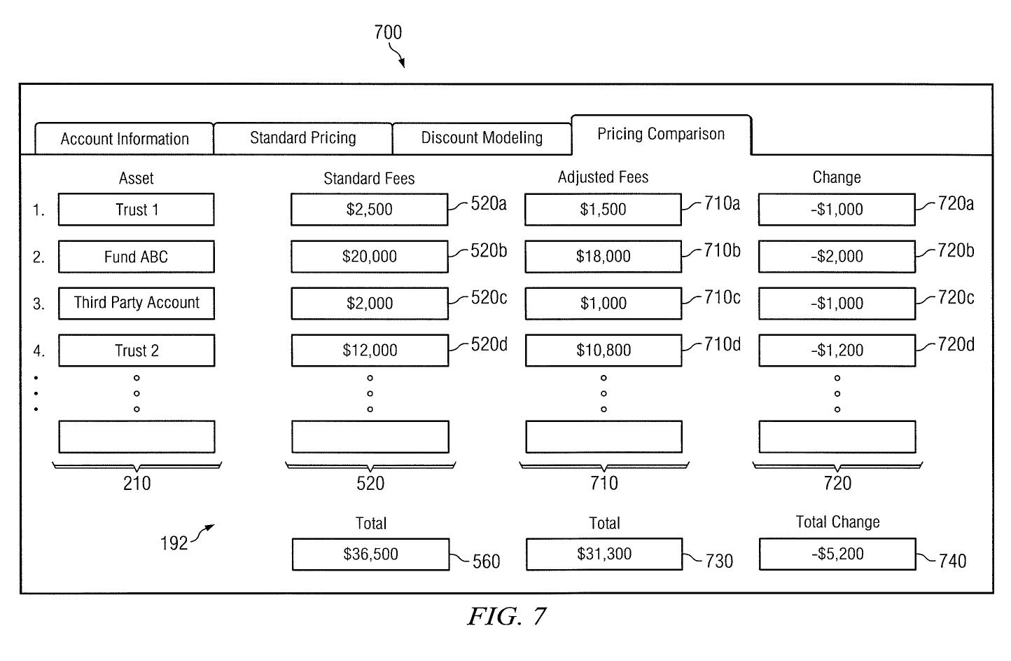

In some embodiments, client 115 may include a graphical user interface (GUI) 180. GUI 180 is generally operable to tailor and filter data presented to user 135. GUI 180 may provide user 135 with an efficient and user-friendly presentation of account data 185, standard asset management fees 190, and adjusted fees such as adjusted fees 710 described below in reference to FIG. 7. GUI 180 may comprise a plurality of displays having interactive fields, pull-down lists, and buttons operated by user. GUI 180 may include multiple levels of abstraction including groupings and boundaries. It should be understood that the term graphical user interface 180 may be used in the singular or in the plural to describe one or more graphical user interfaces 180 and each of the displays of a particular graphical user interface 180.

In some embodiments, network storage device 125 may refer to any suitable device communicatively coupled to network 120 and capable of storing and facilitating retrieval of data and/or instructions. Examples of network storage device 125 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile computer-readable memory devices that store one or more files, lists, tables, or other arrangements of information. In certain embodiments, network storage device 125 may be a SQL Server database.

In some embodiments, market data servers 130 may include any suitable server communicatively coupled to network 120 and capable of delivering market data 197 to pricing server 140. In some embodiments, market data server 130 may be a web server that provides quotes on stock and fund prices from indexes such as the Dow Jones Industrial Average, the NASDAQ, and the S&P 500, among others.

In certain embodiments, network 120 may refer to any interconnecting system capable of transmitting audio, video, signals, data, messages, or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, enterprise 110 may refer to a financial institution such as a bank and may include one or more pricing servers 140, an administrator workstation 145, and an administrator 150. In some embodiments, pricing server 140 may refer to any suitable combination of hardware and/or software implemented in one or more modules to process data and provide the described functions and operations. In some embodiments, the functions and operations described herein may be performed by a pool of pricing servers 140. In some embodiments, pricing server 140 may include, for example, a mainframe, server, host computer, workstation, web server, file server, a personal computer such as a laptop, or any other suitable device operable to process data. In some embodiments, pricing server 140 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. In some embodiments, pricing server 140 may be a web server running Microsoft's Internet Information Server™.

In general, pricing server 140 provides automated fee pricing to users 135. In some embodiments, pricing servers 140 may include a processor 155, server memory 160, an interface 165, an input 170, and an output 175. Server memory 160 may refer to any suitable device capable of storing and facilitating retrieval of data and/or instructions. Examples of server memory 160 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile computer-readable memory devices that store one or more files, lists, tables, or other arrangements of information. Although FIG. 1 illustrates server memory 160 as internal to pricing server 140, it should be understood that server memory 160 may be internal or external to pricing server 140, depending on particular implementations. Also, server memory 160 may be separate from or integral to other memory devices to achieve any suitable arrangement of memory devices for use in system 100.

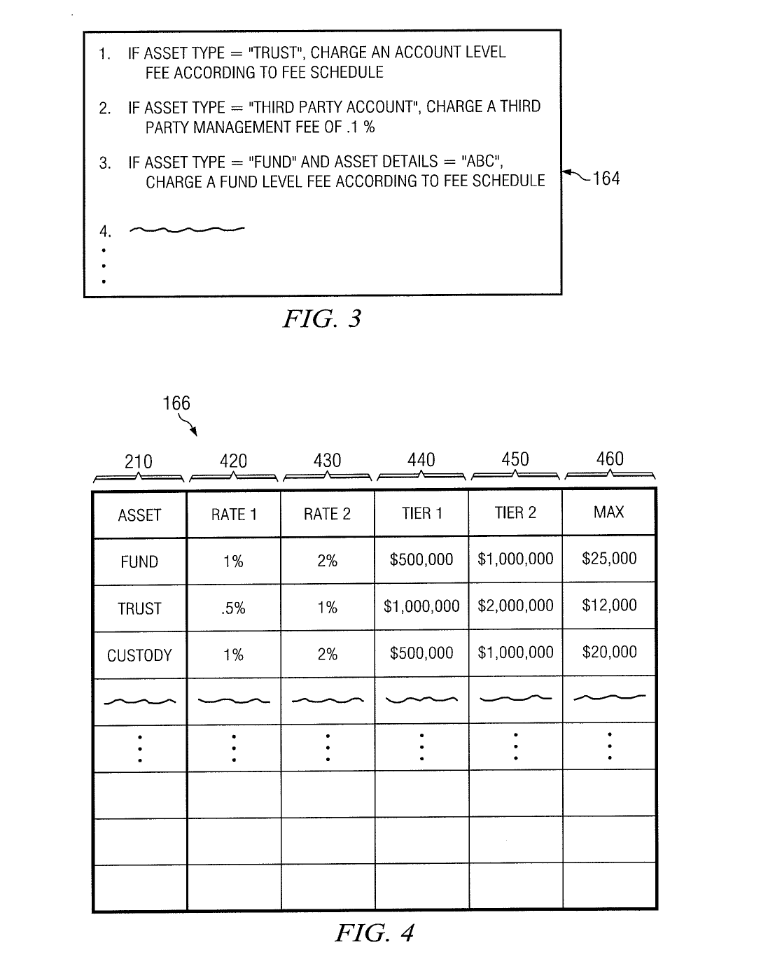

Server memory 160 is generally operable to store an application 162, fee rules 164, a fee schedule 166, and list of asset types 168. Application 162 generally refers to logic, rules, algorithms, code, tables, and/or other suitable instructions for performing the described functions and operations. Fee rules 164 may be any list of rules, standards, policies, limitations, and/or any number and combination of suitable guidelines regarding the calculation of fees. A particular embodiment of fee rules 164 is described in more detail below in reference to FIG. 3. Fee schedule 166 may include any list of assets and their associated fees. A particular embodiment of fee schedule 166 is described in more detail below in reference to FIG. 4. List of asset types 168 may include any list of applicable asset types to be managed by enterprise 110.

Server memory 160 is communicatively coupled to processor 155. Processor 155 is generally operable to execute application 162 stored in server memory 160 to provide automated fee pricing according to the disclosure. Processor 155 may comprise any suitable combination of hardware and software implemented in one or more modules to execute instructions and manipulate data to perform the described functions for pricing servers 140. In some embodiments, processor 155 may include, for example, any type of central processing unit (CPU).

In some embodiments, communication interface 165 (I/F) is communicatively coupled to processor 155 and may refer to any suitable device operable to receive input for pricing server 140, send output from pricing server 140, perform suitable processing of the input or output or both, communicate to other devices, or any combination of the preceding. Communication interface 165 may include appropriate hardware (e.g. modem, network interface card, etc.) and software, including protocol conversion and data processing capabilities, to communicate through a LAN, WAN, or other communication system that allows pricing server 140 to communicate to other devices. Communication interface 165 may include any suitable software operable to access data from various devices such as clients 115, network storage device 125, and/or market data servers 130. Communication interface 165 may also include any suitable software operable to transmit data to various devices such as clients 115, network storage device 125, and/or market data servers 130. Communication interface 165 may include one or more ports, conversion software, or both.

In some embodiments, input device 170 may refer to any suitable device operable to input, select, and/or manipulate various data and information. Input device 170 may include, for example, a keyboard, mouse, graphics tablet, joystick, light pen, microphone, scanner, or other suitable input device. Output device 175 may refer to any suitable device operable for displaying information to a user. Output device 175 may include, for example, a video display, a printer, a plotter, or other suitable output device.

In general, administrator 150 may interact with pricing server 140 using an administrator workstation 145. In some embodiments, administrator workstation 145 may be communicatively coupled to pricing server 140 and may refer to any suitable computing system, workstation, personal computer such as a laptop, or any other device operable to process data. In certain embodiments, an administrator 150 may utilize administrator workstation 145 to manage pricing server 140 and any of the data stored in server memory 160 and/or network storage device 125.

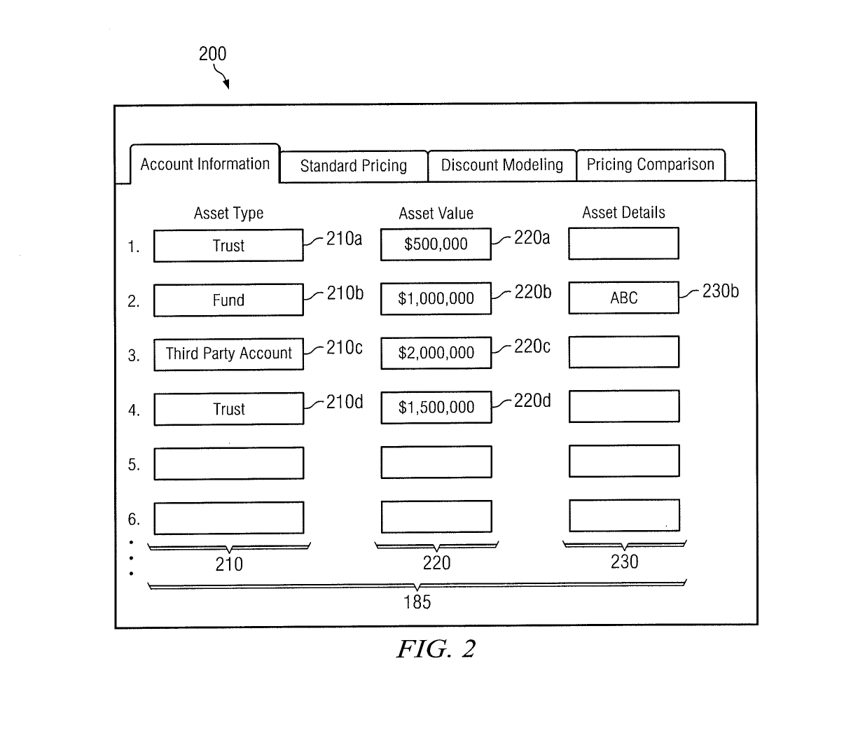

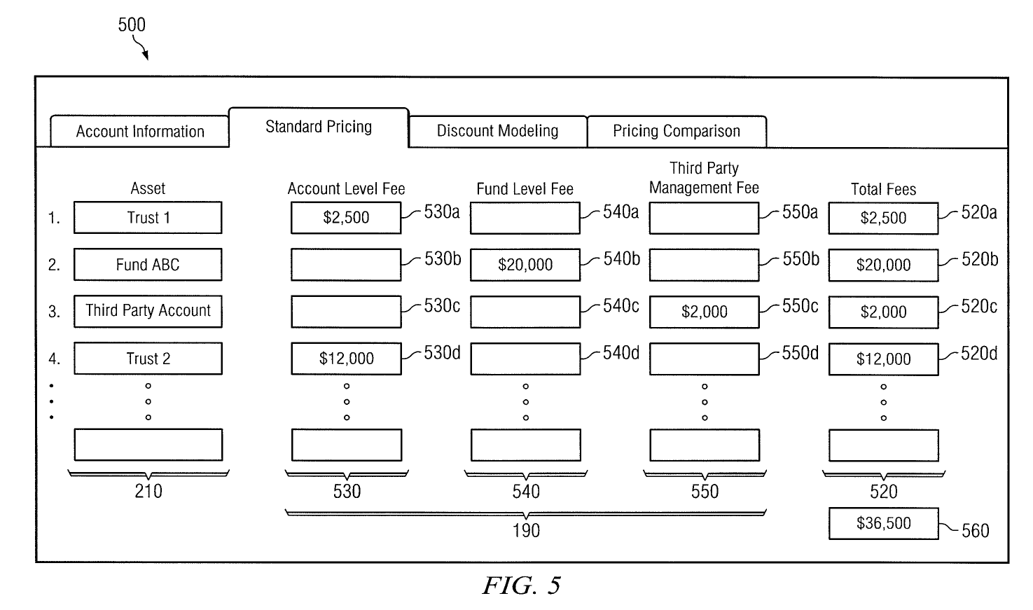

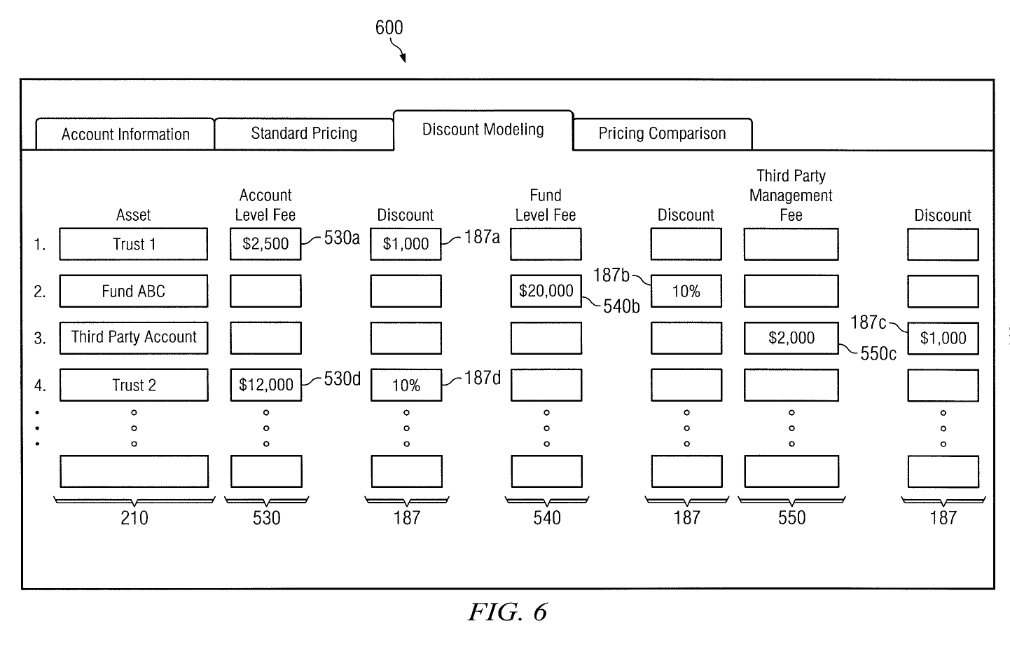

In operation, application 162, upon execution by processor 155, provides automated fee pricing to users 135. To provide automated fee pricing, application 162 may first receive account data 185 from users 135 via clients 115. For example, FIG. 2 discussed below illustrates a screenshot of an account information window 200 where user 135 may enter account data 185. Application 162 may then calculate and display standard asset management fees 190 to user 135. For example, FIGS. 3 and 4 discussed below illustrate example embodiments of fee rules 164 and fee schedule 166 that may be utilized by application 162 to calculate standard asset management fees 190. In addition, FIG. 5 discussed below illustrates an example screenshot of a standard pricing window 500 that may be generated by application 162 to display standard asset management fees 190. User 135 may then provide discount factors 187 to application 162 in order to reduce standard asset management fees 190. For example, FIG. 6 discussed below illustrates an example screenshot of a discount modeling window 600 where user 135 may enter discount factors 187. Application 162 may then calculate adjusted asset management fees 710 based on discount factors 187 and provide a fee comparison 192 to user 135. FIG. 7 discussed below illustrates an example screenshot of a pricing comparison window 700 that may be generated by application 162 to display fee comparison 192.

FIG. 2 illustrates a screenshot of an account information window 200 where user 135 may enter account data 185. Account information window 200 may be one embodiment of GUI 180 of system 100 in which users 135 may enter account data 185 and transmit account data 185 to application 162 in pricing server 140. Account information window 200 may include one or more asset types 210 and an asset value 220 associated with each asset type 210. In certain embodiments, account information window 200 may also include one or more asset details 230 associated with each asset type 210.

As an example for illustrative purposes only, user 135 may be presented with account information window 200 as GUI 180 on display 195 of client 115. User 135 may then enter the following example account data 185 using client 115: an asset type 210a of “trust” having an asset value 220a of $500,000; an asset type 210b of “fund” having an asset value 220b of $1,000,000 and an asset detail 230b of “ABC”; an asset type 210c of “third party account” having an asset value 220c of $2,000,000; and an asset type 210d of “trust” having an asset value 220d of $1,500,000. Client 115 may then transmit the entered asset types 210, asset values 220, and asset details 230 to application 162 as account data 185.

In certain embodiments, asset types 210 of account information window 200 may be provided as a selection to user 135. In certain embodiments, asset types 210 may be populated from a list coded into application 162. In other embodiments, asset types 210 may be populated from a list of asset types 168 that may be stored in server memory 160 and/or network storage device 125. Application 162 may access the internally coded asset types 210 and/or list of asset types 168 and present them to user 135 as a list and/or a drop-down selection box in account information window 200. In certain embodiments, administrator 150 may maintain list of asset types 168 and may update it as needed.

In certain embodiments, asset details 230 may include any type of information related to asset types 210. For example, asset details 230 may include the name and/or symbol of a fund, a particular allocation of an asset type, or any other information pertinent to the disclosed calculation of asset management fees. As an example, asset type 210b of account information window 200 includes an asset detail 230b of “ABC” which refers to the symbol of the fund of asset type 210b. After receiving account data 185, application 162 may proceed to calculate standard asset management fees 190 by first determining one or more fee rules as described below.

In certain embodiments, application 162 may determine one or more rules for calculating asset management fees after receiving account data 185. In certain embodiments, application 162 may determine the one or more rules based on the one or more asset types 210 in received account data 185. For example, FIG. 3 illustrates one embodiment of fee rules 164. Fee rules 164 may be a list of fee rules stored in server memory 160, network storage device 125, and/or internally coded into application 162. Fee rules 164 may include rules used by application 162 to determine the appropriate asset management fees to charge. In the illustrated embodiment, for example, fee rules 164 includes a first rule that if an asset type 210 of account data 185 is equal to “trust”, then an account level fee should be charged according to a fee schedule (such as fee schedule 166 described below.) Thus, application 162 may receive asset types 210a and 210d described above and determine that their values of “trust” match the condition of the first rule of fee rules 164. As a result, application 162 may determine that the first rule of fee rules 164 applies to asset types 210a and 210d. Similarly, application 162 may determine that the second rule of fee rules 164 applies to asset type 210c, and that the third rule of fee rules 164 applies to asset type 210b.

In certain embodiments, application 162 may calculate one or more standard asset management fees (such as standard asset management fees 190 discussed below) based on received account data 185, the determined one or more rules from fee rules 164, and a fee schedule such as fee schedule 166 discussed in detail below in reference to FIG. 4. In some embodiments, application 162 may provide a standard pricing window 500 that displays the calculated standard asset management fees 190 to user 135. Standard pricing window 500 is described below in reference to FIG. 5.

FIG. 4 illustrates one embodiment of fee schedule 166 that may be utilized by application 162 to calculate one or more standard asset management fees. Fee schedule 166 may be stored in server memory 160, network storage device 125, and/or internally coded into application 162. In certain embodiments, fee schedule 166 may include asset types 210, a first fee rate 420, a second fee rate 430, a first fee tier 440, a second fee tier 450, and a maximum fee 460. In certain embodiments, fee rates 420 and 430 may refer to various percentages of the asset value 220 of asset type 210 that is to be charged to a customer as an asset management fee. For example, fee rate 420 may refer to a percentage of the asset value 220 of asset type 210 that is to be charged a customer if asset value 220 is less than the value of first fee tier 440. Similarly, fee rate 430 may refer to a percentage of the asset value 220 of asset type 210 that is to be charged a customer if asset value 220 is greater than first fee tier 440 but less than the value of second fee tier 450. In certain embodiments, maximum fee 460 may refer to a maximum fee to be charged to a customer for a respective asset type 210. Fee schedule 166 may be utilized by application 162 to calculate one or more standard asset management fees as illustrated below.

FIG. 5 illustrates a screenshot of a standard pricing window 500. Standard pricing window 500 may be one embodiment of GUI 180 of system 100 in which users 135 may view standard asset management fees 190 calculated by application 162. Standard pricing window 500 may include asset types 210, standard asset management fees 190, total asset type fees 520, and total asset management fees 560. In certain embodiments, standard asset management fees 190 may include any type of asset management fees including, but not limited to, account level fees 530, fund level fees 540, and third party management fees 550. In certain embodiments, total asset type fees 520a-520d may be a sum of standard asset management fees 530a-550a, respectively. In certain embodiments, total asset management fee 560 may be a sum of total asset type fees 520 and may represent the total fee to be charged to a customer. In certain embodiments, standard pricing window 500 may include more or fewer types of standard asset management fees 190 as illustrated in FIG. 5. Standard pricing window 500 may be utilized by application 162 to display calculated standard asset management fees 190 as described below.

Application 162 may calculate one or more standard asset management fees 190 for received account data 185 based on the determined one or more rules from fee rules 164 and fee schedule 166. In certain embodiments, application 162 may first determine an appropriate standard asset management fee 190 to calculate for asset type 210 of account data 185. For example, as described above for the illustrated example of account data 185 in FIG. 2, application 162 may determine that the first rule of fee rules 164 applies to asset types 210a and 210d, the second rule of fee rules 164 applies to asset type 210c, and that the third rule of fee rules 164 applies to asset type 210b. Application 162 may then analyze the appropriate rules of fee rules 164 to determine which standard asset management fee 190 to calculate. According to the illustrated example of fee rules 164, asset types 210a and 210d should be charged an account level fee 530 according to fee schedule 166, asset type 210c should be charged a third party management fee 550 of 0.1%, and asset type 210b should be charged a fund level fee according to fee schedule 166.

In certain embodiments, application 162 may retrieve market data 197 from market data servers 130 to calculate the one or more standard asset management fees 190. For example, application 162 may need to know the value of a particular fund or stock on a certain date in order to calculate the appropriate standard asset management fee 190. Application 162 may communicate with and retrieve the appropriate market data 197 from market data servers 130 and utilize market data 197 to calculate the appropriate standard asset management fee 190.

Once the appropriate standard asset management fee 190 is determined, application 162 may analyze account data 185 and fee schedule 166 to determine an appropriate rate to apply to asset values 220. For example, after determining that asset types 210a, 210b, and 210d should be charged fees according to fee schedule 166, application 162 may determine whether to apply first fee rate 420 or second fee rate 430 by comparing asset values 220 to first fee tier 440 and second fee tier 450. In the illustrated embodiment, asset type 210a is equal to “trust” and its corresponding asset value 220a is equal to $500,000. Because application 162 previously determined that the first rule of fee rules 164 applies to asset types 210a and 210d, application 162 may calculate an account level fee 530 according to fee schedule 166. For asset type 210a, application 162 may determine that first fee rate 420 applies because $500,000 is less than first fee tier 440 corresponding to asset type 210 of “trust”. As a result, application 162 may calculate that standard asset management fee 190 for asset type 210a should be account level fee 530a of $500,000×0.5%=$2,500.

Likewise, asset type 210d is equal to “trust” and its corresponding asset value 220d is equal to $1,500,000. Therefore, application 162 may determine that second fee rate 430 applies because $1,500,000 is greater than first fee tier 440 but less than second fee tier 450 corresponding to asset type 210 of “trust”. As a result, application 162 may calculate that standard asset management fee 190 for asset type 210d should be account level fee 530d of $1,500,000×1%=$15,000. However, because maximum fee 460 corresponding to asset type 210 of “trust” in fee schedule 166 is equal to $12,000 and is less than the calculated account level fee 530d, application 162 may determine that account level fee 530d should be equal to maximum fee 460 of $12,000.

Application 162 may calculate standard asset management fee 190 for asset type 210b in a similar fashion as for asset types 210a and 210d above. For example, asset type 210b is equal to “fund” and its corresponding asset value 220b is equal to $1,000,000 in the above example. Because application 162 previously determined that the third rule of fee rules 164 applies to asset type 210b, application 162 may calculate a fund level fee 540b according to fee schedule 166. To do so, application 162 may determine that second fee rate 430 applies because $1,000,000 is less than or equal to second fee tier 450 corresponding to asset type 210 of “fund”. As a result, application 162 may calculate that standard asset management fee 190 for asset type 210b should be fund level fee 540b of $1,000,000×2%=$20,000. Because the calculated fund level fee 540b of $20,000 is less than the maximum fee 460 corresponding to asset type “fund”, application 162 may determine that fund level fee 540b should be the calculated amount of $20,000.

Application 162 may calculate standard asset management fee 190 for asset type 210c similar to methods described above. However, because application 162 previously determined that the second rule of fee rules 164 applies to asset type 210c, application 162 may calculate a fund level fee 540b according to the instructions in the determined fee rule. For example, asset type 210c is equal to “Third Party Account” and its corresponding asset value 220c is equal to $2,000,000 in the above example. According to the second rule of fee rules 164, an asset type 210 equal to “third party account” should be charged a third party management fee 550 of 0.1%. As a result, application 162 may calculate that standard asset management fee 190 for asset type 210c should be third party management fee 550c of $2,000,000×0.1%=$2,000.

In certain embodiments, standard pricing window 500 may include total asset type fees 520a-520d and total asset management fee 560 as previously described. For example, total asset type fee 520a may be a sum of account level fee 530a, fund level fee 540a, and third party management fee 550a associated with asset type 210 equal to “trust 1”. Likewise, total asset type fees 520b-520d may be a sum of account level fees 530b-530d, fund level fees 540b-540d, and third party management fees 550b-550d, respectively. In certain embodiments, total asset management fee 560 may be a sum of total asset type fees 520 and may represent the total fee to be charged to a customer.

In some situations, user 135 may have negotiated with a customer and agreed upon reduced fees for the customer. To accommodate such a situation, system 100 provides user 135 with the ability to enter a discount factor and/or a negotiated fee to be used instead of the calculated standard asset management fee 190. FIG. 6 below illustrates one embodiment that allows user 135 to override standard asset management fee 190 and account for negotiated fee pricing.

FIG. 6 illustrates a screenshot of a discount modeling window 600. Discount modeling window 600 may be one embodiment of GUI 180 of system 100 in which users 135 may view standard asset management fees 190 calculated by application 162 and then enter information concerning negotiated and/or discounted fees. Discount modeling window 600 may include asset types 210, account level fees 530, fund level fees 540, third party management fees 550, and discount factors 187. Each discount factor 187 corresponds to a respective account level fee 530, fund level fee 540, or third party management fee 550 and provides an area for user 135 to enter discounted fee information. User 135 may enter discount factors 187 using discount modeling window 600 and then transmit discount factors 187 to application 162 where they may be used to calculate adjusted asset management fees 710 described below in reference to FIG. 7.

In certain embodiments, discount factors 187 may include any type of information related to discounts off of the standard asset management fees 190 previously calculated and provided by application 162. In certain embodiments, discount factors 187 may include an amount of money to be subtracted from an account level fee 530, fund level fee 540, or third party management fee 550. Alternatively or additionally, discount factors 187 may include a percentage to be subtracted from an account level fee 530, fund level fee 540, or third party management fee 550. For example, user 135 may enter a value of $1,000 as discount factor 187a, a value of 10% as discount factor 187b, a value of $1,000 as discount factor 187c, and a value of 10% as discount factor 187d. Discount factors 187 may then be transmitted to application 162 in pricing server 140. Once application 162 receives discount factors 187, application 162 may calculate adjusted fees and provide a pricing comparison 192 to user 135 as described in more detail below.

In certain embodiments, application 162 may receive one or more discount factors 187 associated with standard asset management fees 190 as described above. Application 162 may then calculate an adjusted asset management fee 710 based on discount factor 187 and standard asset management fee 190. For example, application 162 may receive discount factors 187a and 187c having a value of $1,000 and being associated with account level fees 530a and 530c, respectively, as described above. Application 162 may then subtract $1,000 from the calculated account level fees 530a and 530c to obtain adjusted asset management fees 710a and 710c of $1,500 and $1,000, respectively. Similarly, application 162 may receive discount factors 187b and 187d having a value of 10% and being associated with account level fees 530b and 530d, respectively, as described above. Application 162 may then subtract 10% from the calculated account level fees 530b and 530d to obtain adjusted asset management fees 710a and 710c of $18,000 and $10,800, respectively. In some embodiments, a comparison 192 of adjusted asset management fees 710 and standard asset management fees 190 may be provided as described in more detail below.

FIG. 7 illustrates a screenshot of a pricing comparison window 700 where certain embodiments may display a comparison 192 of adjusted asset management fees 710 and standard asset management fees 190 described above. Pricing comparison window 700 may be one embodiment of GUI 180 of system 100. In certain embodiments, pricing comparison window 700 may include asset types 210, total asset type fees 520, adjusted asset management fees 710, fee changes 720, total asset management fees 560, total adjusted fees 730, and total change in fees 740. Fee changes 720 may be the value of standard fees 520 subtracted from adjusted fees 710 for each respective asset type 210. Fee changes 720 may be, for example, a value and/or a percentage change in standard fees 520. In certain embodiments, total adjusted fees 730 may be provided that indicates the sum of adjusted fees 710. In certain embodiments, total change in fees 740 may be provided that indicates a sum of fee changes 720. As a result, user 135 may be able to quickly and efficiently compare standard asset management fees 190 with adjusted asset management fees 710.

In some embodiments, user 135 may interact with application 162 and decide to save his work for later use. As a result, application 162 may store account data 185, standard asset management fees 190, discount factors 187, and/or adjusted fees 710 in server memory 160 and/or network storage device 125. When user 135 wishes to resume, application 162 may retrieve account data 185, standard asset management fees 190, discount factors 187, and/or adjusted fees 710 from server memory 160 and/or network storage device 125.

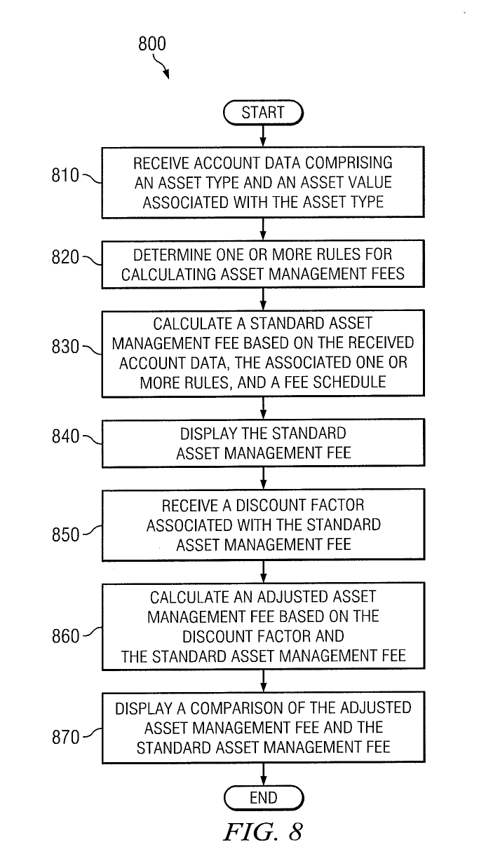

FIG. 8 illustrates one embodiment of a method 800 for providing automated fee pricing. Method 800 begins in step 810 where account data comprising an asset type and an asset value associated with the asset type is received. In some embodiments, the received account data may be account data 185 described above. In certain embodiments, the asset type and the value associated with the asset type in the received account data may refer to asset types 210 and asset values 220, respectively, as described above.

In step 820, one or more rules for calculating asset management fees are determined based on the asset type received in step 810. In certain embodiments, for example, the determined one or more rules for calculating asset management fees may refer to fee rules 164 described above.

In step 830, a standard asset management fee may be calculated based on the account data received in step 810, the one or more rules determined in step 820, and a fee schedule. The fee schedule of step 830 may refer to fee schedule 166 described above. In step 840, the standard asset management fee calculated in step 830 may be displayed. For example, the standard asset management fee may be displayed as GUI 180 on display 195 of client 115 as described above.

In step 850, a discount factor associated with the standard asset management calculated in step 830 is received. The discount factors received in step 850 may refer to discount factor 187 described above. In step 860, an adjusted asset management fee may be calculated based on the discount factor received in step 850 and the standard asset management fee calculated in step 830. The adjusted asset management fee calculated in step 860 may refer to adjusted fees 710 described above. In step 870, a comparison of the adjusted asset management fee calculated in step 860 and the standard asset management fee calculated in step 830 may be displayed. For example, the comparison of step 870 may be displayed as GUI 180 on display 195 of client 115 as described above. After step 870, method 800 ends.

Although the present invention has been described in detail, it should be understood that various changes, substitutions, and alterations can be made hereto without departing from the scope of the invention as defined by the appended claims.

What is claimed is:

1. A system, comprising:
a memory operable to store a list of fee rules and a fee schedule; and
a processor communicatively coupled to the memory and operable to:
receive account data comprising an asset type and an asset value associated with the asset type;
determine, based on the asset type, one or more rules for calculating asset management fees from the list of fee rules;
calculate a standard asset management fee based on the received account data, the determined one or more rules, and the fee schedule;
receive a discount factor associated with the standard asset management fee; and
calculate an adjusted asset management fee based on the discount factor and the standard asset management fee.

2. The system of claim 1, wherein the processor is further operable to determine a particular standard asset management fee to charge based on the asset type.

3. The system of claim 1, wherein the processor is further operable to generate a comparison of the adjusted asset management fee and the standard asset management fee.

4. The system of claim 1, wherein the fee schedule comprises one or more fee rates, each fee rate associated with a respective fee tier.

5. The system of claim 1, wherein the processor is further operable to display the standard asset management fee.

6. The system of claim 1, wherein the processor is further operable to display a comparison of the adjusted asset management fee and the standard asset management fee.

7. The system of claim 1, wherein the processor is further operable to provide a discount modeling window in a graphical user interface to a user, the discount modeling window operable to accept the discount factor from the user and transmit the discount factor to the processor.

8. A method of calculating fees comprising:
receiving at a computing system account data comprising an asset type and an asset value associated with the asset type;
determining by the computing system, based on the asset type, one or more rules for calculating asset management fees;
calculating by the computing system a standard asset management fee based on the received account data, the determined one or more rules, and a fee schedule;
receiving at the computing system a discount factor associated with the standard asset management fee; and
calculating by the computing system an adjusted asset management fee based on the discount factor and the standard asset management fee.

9. The method of claim 8, further comprising determining a particular standard asset management fee to charge based on the asset type.

10. The method of claim 8, further comprising generating a comparison of the adjusted asset management fee and the standard asset management fee.

11. The method of claim 8, wherein the fee schedule comprises one or more fee rates, each fee rate associated with a respective fee tier.

12. The method of claim 8, further comprising displaying the standard asset management fee.

13. The method of claim 8, further comprising displaying a comparison of the adjusted asset management fee and the standard asset management fee.

14. The method of claim 8, further comprising providing a discount modeling window in a graphical user interface to a user, the discount modeling window operable to accept the discount factor from the user and transmit the discount factor to the computing system.

15. Logic embedded in a computer readable medium and operable when executed by a processor to:
receive account data comprising an asset type and an asset value associated with the asset type;
determine, based on the asset type, one or more rules for calculating asset management fees;
calculate a standard asset management fee based on the received account data, the determined one or more rules, and a fee schedule;
receive a discount factor associated with the standard asset management fee; and
calculate an adjusted asset management fee based on the discount factor and the standard asset management fee.

16. The logic of claim 15, further operable when executed by a processor to determine a particular standard asset management fee to charge based on the asset type.

17. The logic of claim 15, further operable when executed by a processor to generate a comparison of the adjusted asset management fee and the standard asset management fee.

18. The logic of claim 15, wherein the fee schedule comprises one or more fee rates, each fee rate associated with a respective fee tier.

19. The logic of claim 15, further operable when executed by a processor to display the standard asset management fee.

20. The logic of claim 15, further operable when executed by a processor to display a comparison of the adjusted asset management fee and the standard asset management fee.

21. The logic of claim 15, further operable when executed by a processor to provide a discount modeling window in a graphical user interface to a user, the discount modeling window operable to accept the discount factor from the user and transmit the discount factor to the logic.
